(19) United States
(12) Patent Application Publication
(10) Pub. No.: US 2015/0040354 A1
(43) Pub. Date: Feb. 12, 2015

(54) J-RAT

(71) Applicant: Earl Alan Rosenfeld, Surprise, AZ (US)

(72) Inventor: Earl Alan Rosenfeld, Surprise, AZ (US)

(21) Appl. No.: 13/921,222

(22) Filed: Aug. 8, 2013

(51) Int. Cl. B25G 3/18; B25G 1/00

(52) U.S. Cl. CPC B25G 3/18; B25G 1/00
USPC 16/430

(57) ABSTRACT

The holder is a Aluminum pole with a looped rope that has apertures and allows the thumb buttons to hold the tool in place allowing the tools that cleans swimming pools to be carried or stored.

### BACKGROUND OF THE INVENTION

The invention relates to the provision of means whereby a pair of telescoping tubular members may be quickly connected against movement apart and quickly disconnected for removal apart.

It is old in this art to connect a tubular tool connector, or handle, to a tubular pole by providing the former with a pair of opposed spring-urged thumb buttons which fit within opposed apertures in a pole to releaseably connect the handle and pole together.

It is also old in this art to mount the button-carrying spring member within the inner telescoped tubular member and to provide the spring member with operating thumb buttons which extend through a second set of apertures in the inner member, i.e. the pool pole.

### SUMMARY OF THE INVENTION

The present invention differs from the above-described prior art in that the holder is not telescoping or a pool pole. The holder member can hold conventional domestic pool tool. The handle member is further provided with a rope to store and carry the pool tool.

### THE DRAWING

FIG. 1 is a view in perspective of the elements of the subject invention in separated condition.

FIG. 2 is a view in longitudinal section of the elements of the invention in connected relation.

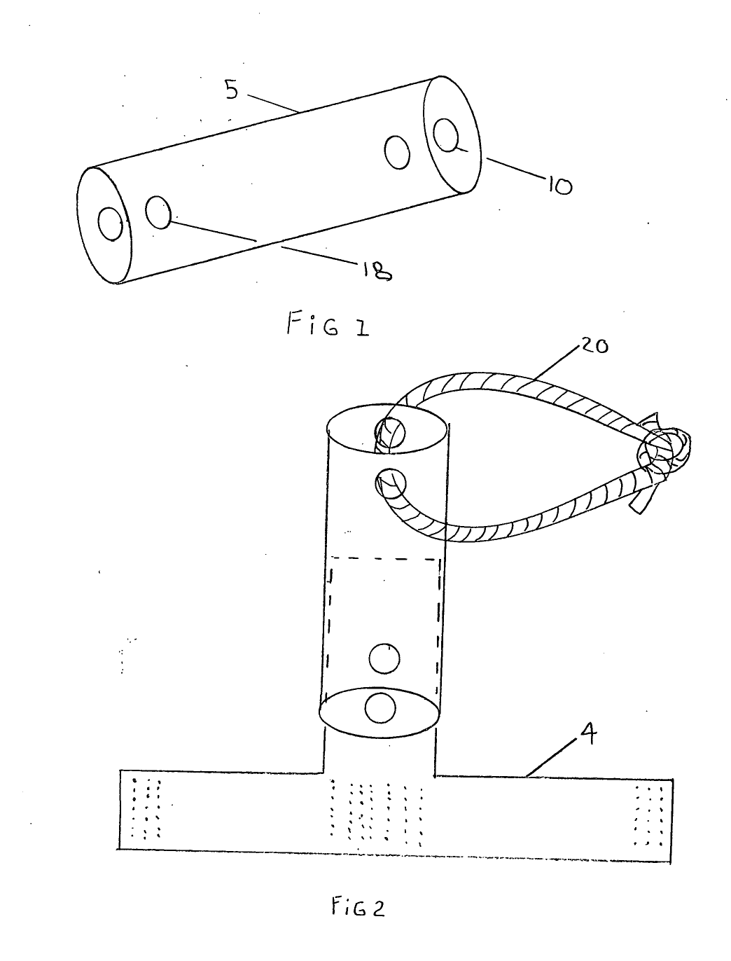

### DESCRIPTION OF PREFERRED EMBODIMENT

With reference to the drawing, the connector comprises holder pole 5 which is provided with pairs of apertures 12 and 10, tool handle 4 which is provided with pairs of apertures 18, and a spring member indicated generally at 15. The member 15 is unitary and wishbone-shaped in form comprising arms 6 and 8, thumb buttons 18. The pool tool 4 is provided with a pair of bottoms 18 whereby the holder 5 may be attached to, for example, a brush 4.

The buttons 18 extend through the apertures on brush 4 and extend through the apertures 10 on holder 5. This is accomplished by pressing the thumb bottons 18 against each other, sliding the compressed member into the handle 5, and rotating the member by turning the holder 5 to permit the thumb buttons 18 to snap into their respective apertures 10. The holder 5 is then attached to the tool shown in FIG. 2. The holder 5 is now locked to the tool 4 and the rope 20 can hang the tool for storage and caring of the tool. Disconnection of the holder and tool is effected by depressing the thumb buttons 18 and by withdrawing the holder from the tool 4.

What is claimed is:

1. A holder is adapted to go over the handle of a pool tool handle, said handle having adjacent its distal end a pair of diametrally opposed first apertures, and having adjacent thereto and aligned therewith a pair of diametrally opposed second apertures, and a wishbone-like spring member positioned within said handle of the tool carried thereby and extending into said first apertures and by a pair of inner opposed thumb buttons carried thereby and extending into said first aperture, said spring member being freeable for removal from said handle by a conjoint and substantially full depressing of said thumb buttons to free the same from said first apertures, said handle being attachable to said holder pole by means comprising a pair of opposed apertures formed in said tool handle adjacent the distal end thereof and by said thumb buttons which are adapted to extend through said second apertures and into said first apertures. The holder of said handle having adjacent its proximal end a pair of diametrally opposed second apertures corresponding in size to said first apertures and the looped rope to hold or hang the tool.
